(19) United States
(12) Patent Application Publication
(10) Pub. No.: US 2007/0147768 A1
(43) Pub. Date: Jun. 28, 2007

(54) Coating tool, coating tool handle, and coating tool set

(76) Inventor: Rira Yasoshima, Tokyo (JP)

Correspondence Address: SEED INTELLECTUAL PROPERTY LAW GROUP PLLC, 701 FIFTH AVE, SUITE 5400, SEATTLE, WA, 98104, US

(21) Appl. No.: 11/347,005

(22) Filed: Feb. 3, 2006

(30) Foreign Application Priority Data
Dec. 26, 2005 (JP) 2005-372716

(51) Int. Cl. G02B 6/00

(52) U.S. Cl. 385/147

(57) ABSTRACT

A coating tool having a handle and a coloring material holding part that are bonded to each other with an adhesive sheet having adhesive layers on its two sides. The adhesive layer on the side of the adhesive sheet for bonding to the coloring material holding part is made of a self-adhesive elastomer. In addition, the coating tool set consisting of one or several coating tool handles, each having the adhesive layer on one side of an adhesive sheet having an adhesive layer on both sides bonded to it, and having the adhesive layer of said adhesive sheet not for bonding with the handle made of a self-adhesive elastomer, and one or several coloring material holding parts for holding the coloring material for coating.

### BACKGROUND OF THE INVENTION

1. Field of the Invention

The present invention pertains to a type of coating tool for applying ink, paint, or other coloring materials, a type of coating tool handle and a type of coating tool set that is a combination of the coating tool handle and a coloring material holding part for holding the coloring material for coating.

2. Description of the Related Art

In the prior art, a stencil or the like is used for applying pigment, ink, paint or other coloring materials to form colored characters, graphs, or patterns.

For the stencil, a stencil paper with characters, graphs or patterns punched in it is fixed on the paper sheet to be painted by means of the stencil. Then, a paint pigment, a water-based paint or stamp pad ink is applied on the brush. The stencil brush is applied lightly to the stencil paper to coat it with ink. The stencil paper is then lifted. As a result, characters, graphs or patterns are copied.

The stencil brush used for stencil operations in the prior art is prepared by arranging a bundle of animal hairs on the tip of a handle made of wood or bamboo, or by arranging a coloring material holding part made of polyurethane or another sponge material on a handle made of wood, bamboo or plastic.

The handle of the stencil brush is made of a buffer material or an elastic material to provide buffering or elasticity, so that the impact of the force applied in using the stencil brush can be absorbed by the buffer material or elastic material of the handle, and the hand of the user does not feel tired even after using the stencil brush for a long time.

With a conventional brush, the handle and the coloring material holding part are bonded and integrated by an adhesive for use.

However, with brush in which the handle and the coloring material holding part are integrated, it is necessary to use a different brush for each color to be painted. Also, a large brush is expensive. Moreover, the container holding multiple brushes is large.

The handle and the coloring material holding part can be separate from each other and can be sold separately. As a result, a handle and plural coloring material holding parts can be purchased at a lower price, and the user himself/herself can bond the handle and the coloring material holding part with an adhesive or bonding agent as needed for use. This is highly economical.

Unfortunately, while a single handle is durable enough to be used to sequentially hold more than one coloring material holding part, when another coloring material holding part is to be used with the handle, it is difficult to peel off the adhesion or bonding agent, and after peeling it off, the peeled-off portion becomes sticky and is difficult to reuse.

### BRIEF SUMMARY OF THE INVENTION

The purpose of the present invention is to solve the aforementioned problems of the prior art by providing a type of coating tool characterized by the fact that the handle and the coloring material holding part can be separated easily and neatly, and the separated handle can be used for several coloring material holding parts. Also, the present invention provides a type of coating tool handle for the coating tool.

Also, with the coating tool set of the present invention, because it consists of one or several coating tool handles and coloring material holding parts, it is possible to combine the coating tool handles and the coloring material holding parts for a variety of applications.

That is, the present invention provides a type of coating tool characterized by the following facts: the coating tool is prepared by bonding a handle and a coloring material holding part that holds the coloring material with an adhesive sheet having an adhesive layer on both sides; the adhesive layer on the side of the adhesive sheet for bonding with the coloring material holding part is made of a self-adhesive elastomer.

The adhesive sheet can consists of a resin layer and two adhesive layers, and the combination can be one of the following: adhesive layer made of a bonding agent/resin layer/adhesive layer made of a self-adhesive elastomer, adhesive layer made of an adhesive/resin layer/adhesive layer made of a self-adhesive elastomer, and adhesive layer made of a self-adhesive elastomer/resin layer/adhesive layer made of a self-adhesive elastomer.

The self-adhesive elastomer can be a self-adhesive polyurethane elastomer.

Also, it is possible for the adhesion between said handle and the adhesive sheet to be greater than that between the coloring material holding part and the adhesive sheet.

The coloring material holding part and adhesive sheet can be bondable and separable by means of the user's hands.

Also, if said adhesive layer made of the self-adhesive elastomer becomes soiled, the original adhesion is restorable by washing it.

The coloring material holding part can be made of a sponge.

A recess that allows for the insertion of two fingers therein can be formed in said handle.

In addition, the present invention provides a type of coating tool handle characterized by the fact that the handle is prepared by bonding the adhesive layer on one side of an adhesive sheet having an adhesive layer on both sides to a handle, and the adhesive layer on the side of said adhesive sheet not for bonding with the handle is made of a self-adhesive elastomer.

Also, the present invention provides a type of coating tool set characterized by the fact that the set is composed of one or several coating tool handles, each of which is prepared by bonding the adhesive layer on one side of an adhesive sheet having adhesive layer on both sides to a handle, with the adhesive layer on the side of said adhesive sheet not for bonding with the handle being made of a self-adhesive elastomer, and one or several coloring material holding parts for holding the coloring material for coating.

The present invention provides a type of coating tool characterized by the fact that the coloring material holding part and the handle can be separated easily and neatly, and the separate handle can be used with multiple coloring material holding parts. Also, the present invention provides a type of coating tool handle for the coating tool.

In addition, the present invention provides a type of coating tool set consisting of one or several coating tool handles and coloring material holding parts, so that combinations of the coating tool handles and coloring material holding parts allow for a variety of applications.

### BRIEF DESCRIPTION OF THE SEVERAL VIEWS OF THE DRAWINGS

FIG. 1A is a bottom plan view illustrating an embodiment of the coating tool of the present invention.

FIG. 1B is a cross-sectional view of the coating tool of FIG. 1A, viewed along Section 1B-1B.

FIG. 2 is a cross section illustrating an alternate embodiment of the coating tool handle of the present invention.

FIG. 3A is a bottom plan view illustrating another alternate embodiment of the coating tool set of the present invention.

FIG. 3B is a cross-sectional view of the coating tool set of FIG. 3A, viewed along Section 3B-3B.

FIG. 4 is a schematic cross section illustrating yet another alternate embodiment of the coating tool set of the present invention.

### DETAILED DESCRIPTION OF THE INVENTION

In the following sections, embodiments of the present invention will be explained in more detail.

In general, the coating tool of the present invention is characterized by the following facts: the coating tool is prepared by bonding a handle and a coloring material holding part that holds the coloring material with an adhesive sheet having an adhesive layer on both sides; the adhesive layer on the side of the adhesive sheet for bonding the coloring material holding part is made of a self-adhesive elastomer.

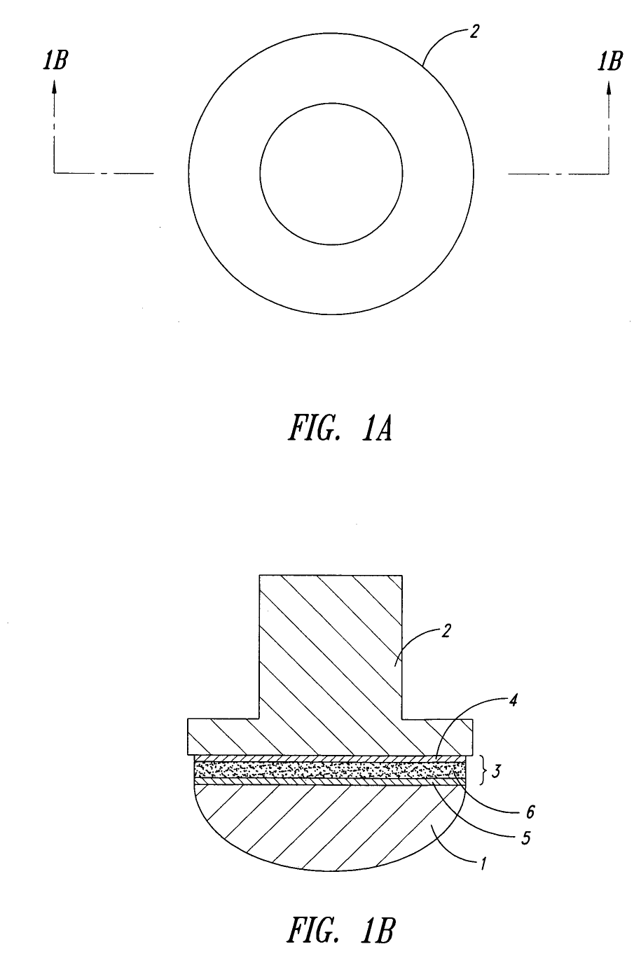

FIGS. 1A and 1B illustrate schematically an embodiment of the coating tool of the present invention, in which FIG. 1B is a cross section, and FIG. 1A is a top plan view. The coating tool of the present invention has coloring material holding part 1 for holding the coloring material for coating, and which is bonded to a handle 2 with adhesive sheet 3 having upper and lower adhesive layers 4, 5 on its two opposing sides, respectively (as viewed in FIG. 1B).

Examples of the coloring materials that can be applied with the coating tool include pigments, inks, paints, stamp inks, etc.

Handle 2 may be made of various conventional materials without specific restrictions. Examples include wood, transparent or opaque resins, foams made of plastics and rubber, other buffering materials, cork, rubber, and other elastic materials.

Coloring material holding part 1 can be made of a sponge material. For example, polyurethane or another plastic sponge is preferred.

Adhesive sheet 3 can be made of a sheet having upper and lower adhesive layers 4, 5, respectively, formed on the two respective sides of a resin layer 6.

Resin layer 6 may be made from a conventional resin sheet, such as a PET or polyester sheet, or from other suitable materials.

The upper adhesive layer 4, set on the side of adhesive sheet 3 for handle 2, is made of an adhesive or a bonding agent. The adhesive or bonding agent may be of a conventional type, such as an acrylic solvent type adhesive. Upper adhesive layer 4 can also be made of a self-adhesive elastomer.

Lower adhesive layer 5, on the surface of adhesive sheet 3 for bonding with coloring material holding part 1, is made of a self-adhesive elastomer. Here, “self-adhesive” means that the elastomer itself has adhesive properties. For example, a self-adhesive polyurethane elastomer can be used as the self-adhesive elastomer. The sheet made of the self-adhesive elastomer is transparent; the dirt or dust attached to the adhesive surface can be removed by water washing, and the adhesion can be recovered after drying. Consequently, it can be used repeatedly. In addition, the adhesive substance does not migrate to the counter side of bonding, so that the counter part is not soiled or scratched. As an example of the property of the self-adhesive elastomer, the adhesion is 270 gf/14 mm (measurement method: pickup type tackmeter).

Examples of the constitution of upper adhesive layer 4/resin layer 6/lower adhesive layer 5 for the adhesive sheet 3 include the structure of bonding agent/resin layer/self-adhesive elastomer, the structure of adhesive/resin layer/self-adhesive elastomer, and the structure of self-adhesive elastomer/resin layer/self-adhesive elastomer. Examples of commercially-available adhesive sheets like this include TG SHEETS™ manufactured by Mochida Shoko K. K. (3 types: PET/self-adhesive polyurethane, adhesive/resin layer/self-adhesive polyurethane rubber, and self-adhesive polyurethane rubber/resin layer/self-adhesive polyurethane rubber). All of these adhesive sheets are transparent.

It is preferred that the adhesion of the adhesive layer to the handle be greater than that of the adhesive layer to the coloring material holding part. The handle 2 and the coloring material holding part 1 bonded to the adhesive sheet 3 can be separated by hand.

With a conventional adhesive, once dirt or dust becomes attached to it, it is difficult to remove the dirt or dust, and the adhesion is effectively lost. This is undesirable. According to the present invention, however the self-adhesive elastomer for bonding the coloring material holding part 1 to the adhesive sheet 3 can be washed to restore the adhesion even when it is soiled. Consequently, it can be used repeatedly. This is an advantage.

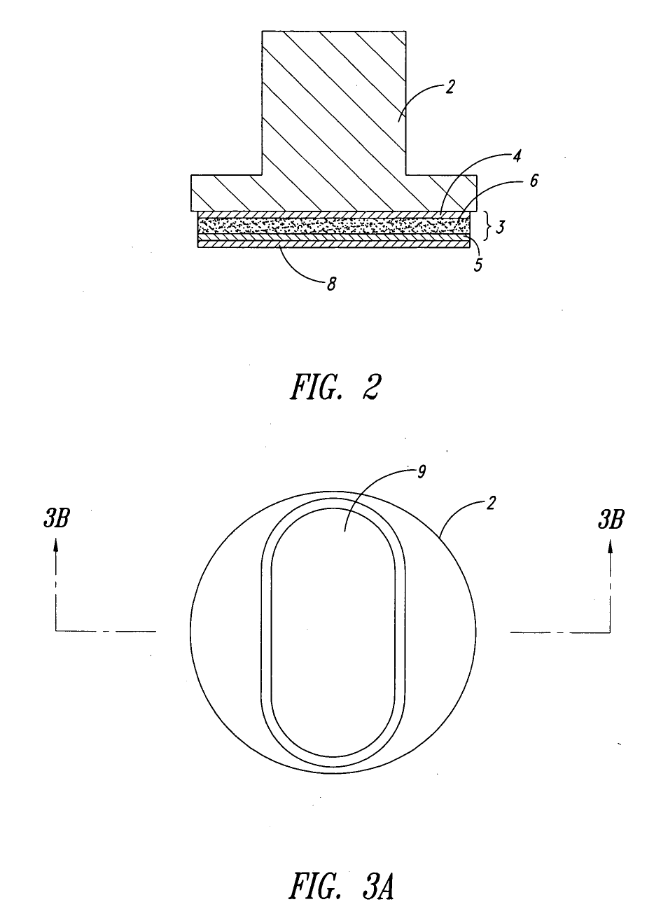

FIG. 2 is a schematic cross section illustrating another embodiment of the coating tool handle of the present invention. For coating tool handle 10 of the present invention, as shown in FIG. 2, handle 2 is bonded to upper adhesive layer 4 on one side of adhesive sheet 3 having an adhesive layer on both sides, just as was explained above. Lower adhesive layer 5 on the side of adhesive sheet 3 not for bonding with the handle 2 is made of a self-adhesive elastomer. Reference number 8 represents a protective film that protects adhesive layer 5 made of a self-adhesive elastomer.

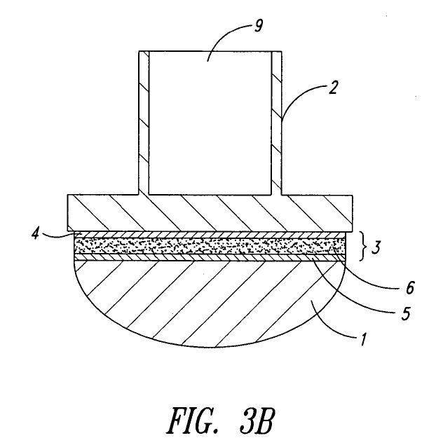

FIGS. 3A and 3B illustrate schematically another embodiment of the coating tool of the present invention, in which FIG. 3B is a cross section, and FIG. 3A is a plan view. The coating tool shown in FIGS. 3A and 3B is characterized by the fact that recess 9 for inserting two fingers is formed in handle 2. For example, said recess 9 allows insertion of the index finger and middle finger to hold handle 2, so that the hand of the user does not get tired even after extended use. This handle also can be used as the coating tool handle shown in connection with other embodiments.

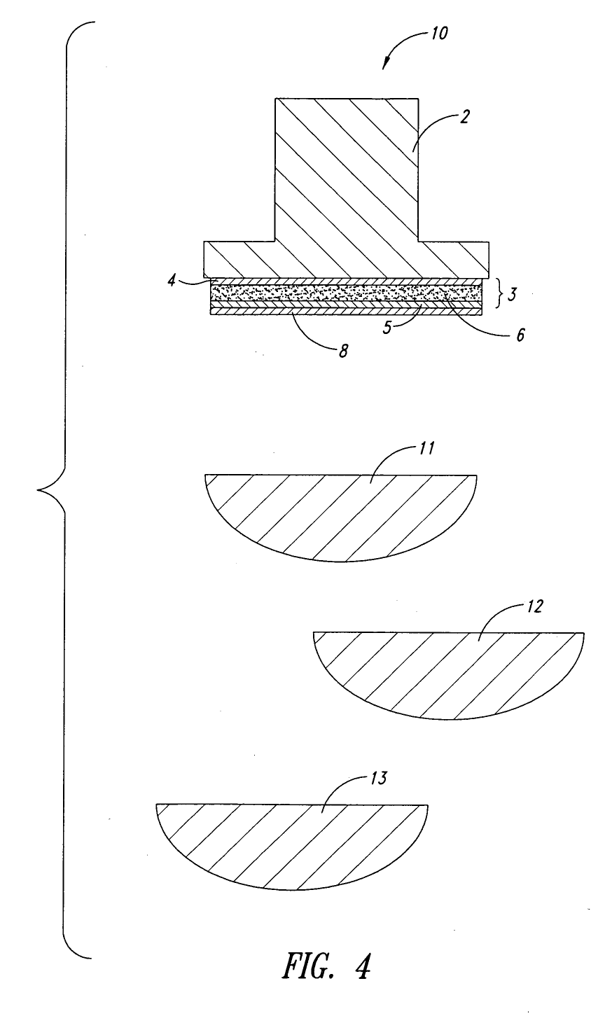

FIG. 4 is a schematic cross section illustrating an embodiment of the coating tool set of the present invention. FIG. 4 shows a set consisting of one coating tool handle 10 and three coloring material holding parts 11, 12, 13 bonded to coating tool handle 10. With the coating tool set shown in FIG. 4, after coating tool handle 10 and coloring material holding part 11 are bonded to each other and a coating operation is performed, coating tool handle 10 and coloring material holding part 11 are separated from each other. Then coating tool handle 10 and coloring material holding part 12 can be bonded together for coating. In the same way, coating tool handle 10 and coloring material holding part 13 can be bonded to each other for a coating operation. Each of the configurations can be repeated, as desired. In this way, the coating tool set can perform coating operations by means of one coating tool handle 10 and two or more coloring material holding parts.

### EXAMPLES

In the following, the present invention will be explained in more detail with reference to application examples.

### Example 1

A coating tool with the constitution shown in FIGS. 1A and 1B is prepared.

A polystyrene resin is used to form the handle 2, and a sponge is used to form the coloring material holding part 1.

A transparent adhesive sheet 3 with a constitution of adhesive/PET/self-adhesive polyurethane rubber (TG SHEET™ manufactured by Mochida Shoko K. K. with a thickness of 1 mm) is bonded to the handle 2 on the side with the adhesive, and to the coloring material holding part on the side with the self-adhesive polyurethane rubber, to form a coating tool.

Then, stenciling is performed using the coating tool. An animal pattern is punched in stencil paper, and the patterned stencil paper is secured in place. Then, the ink from a stamp pad is applied to the coloring material holding part 1 which is then lightly pressed on the stencil paper.

The adhesive sheet 3 has differential adhesion. Here, “differential adhesion” means that the conventional adhesive on one side of the adhesive sheet has greater adhesion, while the self-adhesive polyurethane elastomer on the other side of the adhesive sheet has lower adhesion. Consequently, the adhesive side with the greater adhesion is used for bonding to the handle 2, for which easy separation would be problematic, while the adhesive side with the lower adhesion is used for bonding to the coloring material holding part 1 which needs to be easily separated.

Because the adhesive surface of the self-adhesive polyurethane elastomer on the side of the coloring material holding part 1 can be washed to restore the adhesion if it becomes soiled, it can be used semi-permanently. Also, the coloring material holding part 1 and the handle 2 can be easily and neatly separated.

When the adhesive sheet 3 is made from a soft material, it works like a cushion just like the sponge of the cushion material used in a conventional coloring material holding part 1, so that when the coloring material holding part 1 is pressed, bumps and dips on the paper surface can be absorbed so that a clean image can be realized.

### Example 2

As shown in FIG. 2, a transparent adhesive sheet 3 with a constitution of adhesive/PET/self-adhesive polyurethane rubber (TG SHEET™) manufactured by Mochida Shoko K. K.) is used. A handle 2 is bonded to the side of the adhesive sheet 3 with the upper adhesive 4 to form a coating tool handle 10. A coloring material holding part 1 is prepared separately.

The size of the coating tool handle 10 is variable to allow preparation of plural types of coating tool handles. Also, the size of the coloring material holding part 1 can also be changed to prepare several types. As a result, a set is obtained. Consequently, one can freely combine the coating tool handles 10 and coloring material holding parts 1 to form a variety of coating tools. In this way, since the coating tool handles 10 and coloring material holding parts 1 are prepared separately, the freedom of selection is improved, and the size of the container can be reduced. The resulting cost reduction is significant.

With the coating tool of the present invention, it is easy to separate the coloring material holding part 1 and the handle 2, and it is possible to use a single handle with plural coloring material holding parts, or one or more coating tool handles 10 and coloring material holding parts, for use as a set. As a result, it is possible to combine the coating tool handles 10 and the coloring material holding parts 1 as a set for use.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1-6. (canceled)

7. A coating tool comprising a handle and a coloring material holding part that is made of a sponge and is adapted to hold a coloring material, the handle and the coloring material holding part being bonded together with an adhesive sheet having an adhesive layer on both of its sides; the adhesive layer on the side of the adhesive sheet for bonding to the coloring material holding part being made of a self-adhesive elastomer.

8-10. (canceled)

11. A coating tool set comprising an adhesive sheet and a coating tool handle, the handle being bonded to a first adhesive layer on one side of the adhesive sheet, a second adhesive layer on the side of said adhesive sheet not for bonding with the handle being made of a self-adhesive elastomer, and a plurality of coloring material holding parts for holding the coloring material for coating, the plurality of coloring material holding parts being adapted to be sequentially releasably attached to the second adhesive layer, wherein the coloring material holding parts are made of a sponge.

12. The coating tool described in claim 7 wherein said adhesive sheet consists of a resin layer and two adhesive layers, and the combination is selected from one of the following: adhesive layer made of a bonding agent/resin layer/adhesive layer made of a self-adhesive elastomer, adhesive layer made of an adhesive/resin layer/adhesive layer made of a self-adhesive elastomer, and adhesive layer made of a self-adhesive elastomer/resin layer/adhesive layer made of a self-adhesive elastomer.

13. The coating tool of claim 7 wherein said self-adhesive elastomer is a self-adhesive polyurethane elastomer.

14. The coating tool of claim 7 wherein the adhesion between said handle and the adhesive sheet is greater than that between the coloring material holding part and the adhesive sheet.

15. The coating tool of claim 7 wherein said coloring material holding part and adhesive sheet are adapted to be bonded and separated by hand.

16. The coating tool of claim 7 wherein, if said adhesive layer made of the self-adhesive elastomer is soiled, the original adhesion can be restored by washing it.

17. The coating tool of claim 7 wherein the handle includes a recess that allows the insertion of two fingers for manipulating the coating tool.
